(19) United States
(12) Patent Application Publication
(10) Pub. No.: US 2004/0138882 A1
(43) Pub. Date: Jul. 15, 2004

(54) Acoustic model creating method, speech recognition apparatus, and vehicle having the speech recognition apparatus

(75) Inventor: Yasunaga Miyazawa, Okaya-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/697,105

(22) Filed: Oct. 31, 2003

(30) Foreign Application Priority Data
Oct. 31, 2002 (JP) 2002-318627
Jul. 17, 2003 (JP) 2003-198707

(51) Int. Cl. G10L 15/20

(52) U.S. Cl. 704/233

(57) ABSTRACT

The invention provides an acoustical model creating method that obtains high recognition performance under various noise environments such as the inside of a car. The present invention can include a noise data determination unit, which receives data representing the traveling state of the vehicle, the surrounding environments of the vehicle, and the operational states of apparatuses mounted in the vehicle, and according to the data, determines which noise data of the previously classified n types of noise data corresponds to the current noise. The invention can also include a noise removal processing unit in which the n types of noise data are superposed on standard speech data to create n types of noise-superposed speech data, and then n types of acoustic models M1 to Mn, which are created based on the n types of noise-removed speech data from which noise is removed, and noise-superposed speech from a microphone are input together with the result of the noise type determination, and then noise removal is performed on the noise-superposed speech. The invention can also include a speech recognition processing unit in which speech recognition is performed on the noise-removed speech using the acoustic model corresponding to the noise type which is determined by the noise data determination unit among the n types of acoustic models.

### BACKGROUND OF THE INVENTION

1. Field of Invention

The present invention relates to a speech recognition acoustic model creating method for performing speech recognition within a space having noise, and a speech recognition apparatus. In addition, the present invention relates to a vehicle having the speech recognition apparatus.

2. Description of Related Art

Recently, speech recognition techniques generally have been used in various fields, and various apparatuses have been operated by speech. Since specific apparatuses are operated by speech, it is possible for an operator to conveniently operate one apparatus by speech while operating another apparatus using both hands. Since various apparatuses, such as a car's navigation apparatus, audio apparatus, and air-conditioner mounted on a car, are generally manipulated by a driver's hands, several techniques for operating the apparatuses by speech have been recently proposed and commercialized. Thus, since a driver can turn apparatuses on and off and set the functions of the apparatuses without loosing his hold of the steering wheel, he can safely drive a car. Therefore, it is expected that the apparatuses operated by speech will be widely employed.

However, when operating such apparatuses mounted in a car, etc., using speech, it is important to obtain high recognition performance under an environment where plural types of noise exist. Thus, high recognition performance has been an important issue.

A conventional speech recognition method, in which an acoustic model is created by a method as shown in FIG. 15 and then speech recognition is performed by the resulting acoustic model as shown in FIG. 16, has been used in environments where plural types of noise exist within a car.

Now, an acoustic model creating process used for the conventional speech recognition method will be described with reference to FIG. 15. First, standard speech data V (for example, a large amount of speech data obtained from plural types of words uttered by a number of speakers), which are collected in a noise-free environment, such as an anechoic room, and specific types of noise data N are input to a noise-superposed data creation unit 51. Then, specific types of noise in standard speech data are superposed to each other at a predetermined S/N ratio to create noise-superposed speech data VN.

In a noise removal processing unit 52, a noise removal process suitable for the type of noise, e.g., a spectral subtraction (SS) method or a cepstrum mean normalization (CMN) method, is performed on the noise-superposed speech data VN, and then noise-removed speech data V′ are created. In the noise-removed speech data V′, there are remaining noise components which are not removed by the noise removal process. In addition, in an acoustic model learning processing unit 53, an acoustic model M, such as phoneme HMM (Hidden Markov Model) and syllable HMM, is created using the noise-removed speech data V′.

On the other hand, as shown in FIG. 16, in the conventional speech recognition process, an input signal processing unit 62 amplifies or A/D converts (analog/digital conversion) the speech data of a speaker (speech commands for apparatus operation) inputted from a microphone 61, and then a noise removal processing unit 63 performs the noise removal process (which is the same process performed in the noise removal processing unit 52 shown in FIG. 15) on the input speech data.

In addition, a speech recognition processing unit 64 performs a speech recognition process on speech data in which noise is removed (hereinafter referred to as noise-removed speech data) using a language model 65 and an acoustic model M created from the acoustic model learning processing unit 53.

However, according to the aforementioned conventional speech recognition method, speech recognition is performed using only the acoustic model M that is created corresponding to a specific noise. Thus, it is impossible to cope with a situation in which various types of noise change every moment as described above, and the noise generated by various circumstances has an effect significantly on speech recognition performance. Therefore, it is difficult to obtain a high recognition rate.

With respect to the above, a speech recognition technique is disclosed in the Japanese Unexamined Patent Application Publication No. 2002-132289. The speech recognition technique performs speech recognition by creating plural types of acoustic models corresponding to plural types of noise and by selecting an optimal acoustic model from the plural types of acoustic models in accordance with the noise, which is superposed on the speech, at the time of speech recognition.

### SUMMARY OF THE INVENTION

According to Japanese Unexamined Patent Application Publication No. 2002-132289, since acoustic models corresponding to several types of noise are provided and an optimal acoustic model corresponding to a specific noise is selected to recognize speech, it is possible to perform speech recognition with high accuracy. However, when the speech recognition is performed within a car, noise unique to the car is entered into a microphone and then transmitted to a speech recognition processing unit, with the noise superposed on speech commands. Herein, the noise unique to the car can include sounds relating to the traveling state of the car (pattern noise of tires in accordance with the traveling speed of the car, wind roar according to a degree of opening of the windows, and engine sounds according to RPMs (revolutions per minute) or the location of transmission gears), sounds due to the surrounding environment (echoes generated at the time of passing through a tunnel), sounds due to the operation of apparatuses mounted in the car (sounds relating to the car audio, operation sounds of the air conditioner, and operation sounds of the windshield wipers and the direction indicators), and sounds due to raindrops.

Generally, in a car, the types of noise inputted into the microphone are the aforementioned noise unique to a car. Although the types of car-unique noise are somewhat limited, noise different in magnitude and type is generated by the engine by different traveling circumstances at times of idling, low-speed traveling, and high-speed traveling. Furthermore, even if the car is driven at a constant speed, several types of noise different in magnitude and type can be generated by the engine due to the relationship between high and low RPMs.

In addition to such sounds relating to the traveling state of the car, wind roar according to the degree of opening of the windows, echoes reflected from surrounding structures, such as tunnels and bridges, sounds due to raindrops (the degree of which is different according to the amount of rainfall), and operation sounds of various apparatuses mounted in the car, such as the car audio, the air conditioner, the windshield wipers, and the direction indicators, are input into the microphone as described above.

As described above, although the types of noise generated within the vehicle are somewhat restrictive, even the same type of noise may vary depending upon the circumstance. There are some circumstances in which the technique disclosed in Japanese Unexamined Patent Application Publication No. 2002-132289 does not cope with under such noise environments. Furthermore, the above problems occur in other types of vehicles as well as cars. In addition, even if speech recognition is performed, for example, at a workshop, such as a factory or a market, the same problems that occur when speech recognition is performed within a car will occur although different types of noise are generated in each place.

Accordingly, an object of the present invention is to provide an acoustic model creating method for creating acoustic models to perform speech recognition suitable for noise environments when speech recognition is performed within a space having noise, a speech recognition apparatus capable of obtaining high recognition performance in environments where various types of noise exist, and a vehicle having a speech recognition apparatus capable of surely operating apparatuses by speech in environments where various types of noise exist.

The present invention relates to an acoustic model creating method for performing speech recognition within a space having noise. The method can include a noise collection step of collecting various types of noise collectable within the space having noise, a noise data creation step of creating plural types of noise data by classifying the noise collected from the noise collection step, a noise-superposed speech data creation step of creating plural types of noise-superposed speech data by superposing the plural types of noise data created in the noise data creation step on standard speech data, a noise-removed speech data creation step of creating plural types of noise-removed speech data by performing a noise removal process on the plural types of noise-superposed speech data created in the noise-superposed speech data creation step, and an acoustic model creation step of creating plural types of acoustic models using the plural types of noise-removed speech data created in the noise-removed speech data creation step.

Like this, the noise collected within a certain space is classified to create plural types of noise data. The plural types of noise data are superposed on previously prepared standard speech data to create plural types of noise-superposed speech data. A noise removal process is performed on the plural types of noise-superposed speech data. Then, plural types of acoustic models are created using the plural types of noise-removed speech data. Thus, it is possible to create the optimal acoustic model corresponding to various types of noise within a space.

In the acoustic model creating method described above, the noise removal process performed on the plural types of noise-superposed speech data is carried out using a noise removal method suitable for each of the noise data. Thus, it can be possible to appropriately and effectively remove the noise for each of the noise data.

In the acoustic model creating method described above, the space having noise is a vehicle, for example. Thus, it is possible to create optimal acoustic models corresponding to various types of noise unique to a vehicle (for example, a car).

In the acoustic model creating method described above, various types of noise collectable within the vehicle are plural types of noise due to the effects of at least one of weather conditions, the traveling state of the vehicle, the traveling location of the vehicle, and the operational states of apparatuses mounted in the vehicle.

When the vehicle is a car, the noise includes, for example, engine sound relating to the traveling speed of the car, pattern noise of tires, sounds due to raindrops, the operational states of apparatuses, such as an air conditioner and a car audio mounted on the car. In addition, these sounds are collected as noise. The noise is classified to create noise data corresponding to each noise group, and an acoustic model for each noise data is created. Thus, it is possible to create acoustic models corresponding to various types of noise unique to a vehicle, particularly, a car.

In the acoustic model creating method described above, the noise collection step can include a noise parameter recording step of recording individual noise parameters corresponding to the plural types of noise to be collected, and in the noise data creation step, the plural types of noise to be collected are classified using each noise parameter corresponding to the plural types of noise to be collected, thereby creating the plural types of noise data.

The noise parameters include, for example, information representing the speed of the car, information representing RPMs of engine, information representing the operational state of the air conditioner, and the like. By recording the noise parameters together with the noise, for example, the correspondence between speeds and noise can be obtained, and the appropriate classification can be made. Thus, it is possible to obtain noise data suitable for a real noise environment.

The present invention relates to a speech recognition apparatus for performing speech recognition within a space having noise. The apparatus can include a sound input device for inputting speech to be recognized and other noise, plural types of acoustic models created by an acoustic model creating method. The acoustic model creating method can include a noise collection step of collecting various types of noise collectable within the space having noise, a noise data creation step of creating plural types of noise data by classifying the collected noise, a noise-superposed speech data creation step of creating plural types of noise-superposed speech data by superposing the created plural types of noise data on previously prepared standard speech data, a noise-removed speech data creation step for creating plural types of noise-removed speech data by performing a noise removal process on the created plural types of noise-superposed speech data, and an acoustic model creation step of creating plural types of acoustic models using the created plural types of the noise-removed speech data. The apparatus can also include a noise data determination device for determining which noise data of the plural types of the noise data corresponds to the noise inputted from the sound input device, a noise removal processing device for performing noise removal on the noise-superposed speech data on which the noise inputted from the sound input device is superposed based on the result of the determination of the noise data determination device, and a speech recognition device for performing speech recognition on the noise-removed speech data, from which noise is removed by the noise removal processing device, using one of the plural types of acoustic models corresponding to the noise data determined by the noise data determination device.

Like this, the speech recognition apparatus of the present invention performs the noise data determination for determining which noise data of the plural types of noise data corresponds to the current noise. The noise removal is performed on the noise-superposed speech data based on the result of determination of the noise data. And then, the speech recognition is performed on the noise-removed speech using the acoustic model corresponding to the noise data. In addition, the plural types of acoustic models which the speech recognition apparatus utilizes are the acoustic models created by the aforementioned acoustic model creating method.

By doing so, it is possible to perform the optimal noise removal process for the noise that exists within a space. At the same time, since the speech recognition can be performed using the optimal acoustic model for the noise at that time, it is possible to obtain high recognition performance under noise environments unique to, for example, a car and a workshop.

In the speech recognition apparatus described above, the speech recognition apparatus further comprises noise parameter acquisition means for acquiring noise parameters corresponding to the noise inputted from the sound input device. By preparing the noise parameter acquisition device, it is possible to accurately correspond the noise to be collected with the source of noise.

In the speech recognition apparatus described above, the noise removal process on the plural types of noise data obtained by classification is performed using a noise removal method suitable for each of the noise data. Thus, it is possible to appropriately and effectively remove the noise from each noise data.

In the speech recognition apparatus described above, the space having noise is a vehicle, for example. Thus, it is possible to perform speech recognition in consideration of the effects of various types of noise unique to a vehicle (for example, a car). For example, when a driver operates or sets up the vehicle itself or apparatuses mounted in the vehicle, it is possible to perform speech recognition with high recognition accuracy and thus to surely operate or set up apparatuses by speech.

In the speech recognition apparatus described above, various types of noise collectable within the vehicle are plural types of noise due to the effects of at least one of weather conditions, the traveling state of the vehicle, the traveling location of the vehicle, and the operational states of apparatuses mounted in the vehicle. Thus, it is possible to create acoustic models corresponding to various types of noise unique to a vehicle (for example, a car). Furthermore, it is possible to perform speech recognition in consideration of the effects of the various types of noise unique to the vehicle using the acoustic models and thus to achieve high recognition accuracy.

In the speech recognition apparatus described above, the noise collection step for creating the acoustic models can include a noise parameter recording step of recording individual noise parameters corresponding to the plural types of noise to be collected, and in the noise data creation step, the plural types of noise to be collected are classified using each noise parameter corresponding to the noise to be collected, thereby creating the plural types of noise data. Thus, it is possible to suitably classify the various types of noise unique to a vehicle. Furthermore, it is possible to create acoustic models corresponding to the noise data obtained by the classification. Moreover, it is possible to perform the speech recognition in consideration of the effects of the various types of noise unique to the vehicle using the acoustic models and thus to achieve high recognition accuracy.

In the speech recognition apparatus described above, the noise removal process at the time of creating the plural types of acoustic models and the noise removal process at the time of performing speech recognition on the speech to be recognized are performed using the same noise removal method. Thus, it is possible to obtain high recognition accuracy under various noise environments.

The present invention also relates to a speech recognition apparatus for performing speech recognition within a space having noise using plural types of acoustic models created by an acoustic model creating method described above. The apparatus can include a sound input device for inputting speech to be recognized and other noise, a noise data determination device for determining which noise data of previously classified plural types of noise data corresponds to the current noise inputted from the sound input device, a noise removal processing device for performing noise removal on noise-superposed speech data on which the noise inputted from the sound input device is superposed based on the result of the determination of the noise data determination device, and a speech recognition device for performing speech recognition on the noise-removed speech data, from which noise is removed by the noise removal processing device, using one of the acoustic models corresponding to the noise type determined by the noise data determination device. By such construction of the present invention, it is possible to achieve the same effect as that of the speech recognition apparatus described above.

The present invention relates to a vehicle having a speech recognition apparatus that is able to be operated by speech. The speech recognition apparatus is the speech recognition apparatus described above. Thus, for example, when a driver operates or sets up the vehicle itself or apparatuses mounted in the vehicle by speech, speech recognition can be performed using an acoustic model suitable for the various types of noise unique to the vehicle. Therefore, it is possible to obtain high recognition accuracy. Furthermore, it is possible for a driver to surely operate or sets up apparatuses by speech.

### BRIEF DESCRIPTION OF THE DRAWINGS

The invention will be described with reference to the accompanying drawings, wherein like numerals reference like elements, and wherein:

FIG. 1 is a view illustrating a schematic processing sequence of the acoustic model creating method of the present invention;

FIG. 2 is a view illustrating an acoustic model creating method of the present invention in detail;

FIG. 3 is a view illustrating a process for creating noise data N1 to Nn according to the first embodiment of the present invention;

FIG. 4 is a view illustrating noise data N, which are obtained by collecting the noise generated corresponding to three types of noise parameters for a long time, as one data on three-dimensional coordinates;

FIG. 5 is a view illustrating noise data, which are created for each of noise groups which are obtained by classifying the noise data shown in FIG. 4 simply for each of the noise parameters;

FIG. 6 is a view illustrating noise data which are obtained by classifying the noise data shown in FIG. 5 using a statistical method;

FIG. 7 is a structural view of a speech recognition apparatus according to the first embodiment of the present invention;

FIG. 8 is a view illustrating an example of a vehicle equipped with the speech recognition apparatus of the present invention;

FIG. 9 is a view illustrating a layout of a factory according to the second embodiment of the present invention;

FIG. 10 is a view illustrating a process for creating noise data N1 to Nn according to the second embodiment of the present invention;

FIG. 11 is a view illustrating noise data which are obtained by classifying the collected noise using a statistical methods according to the second embodiment of the present invention;

FIG. 12 is a view illustrating FIG. 11 with two-dimensional cross-section corresponding to each of three operational states of a processing apparatus;

FIG. 13 is a structural view of a speech recognition apparatus according to the second embodiment of the present invention;

FIG. 14 is a structural view illustrating a modified example of the speech recognition apparatus shown in FIG. 7;

FIG. 15 is a view schematically illustrating a conventional acoustic model creating process; and

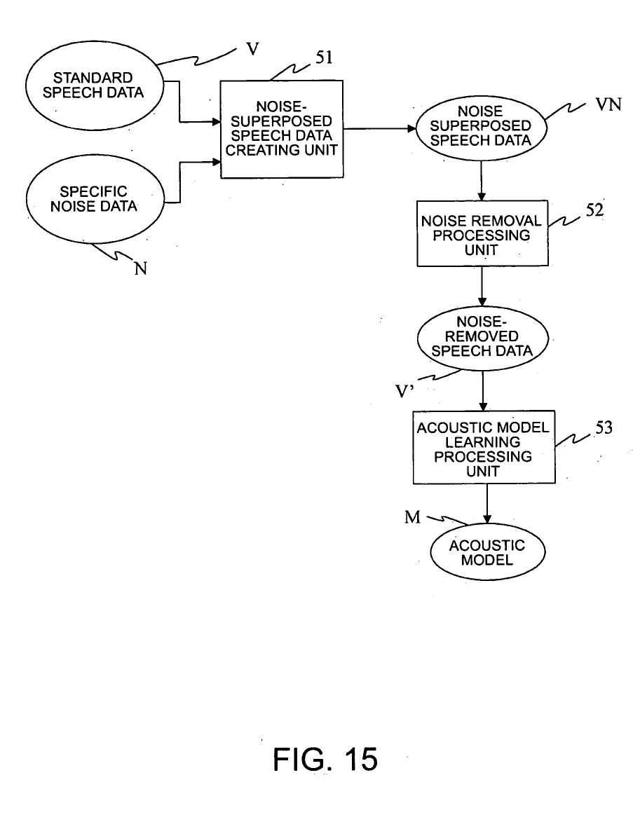

FIG. 16 is a schematic structural view of a conventional speech recognition apparatus using the acoustic model created in FIG. 15.

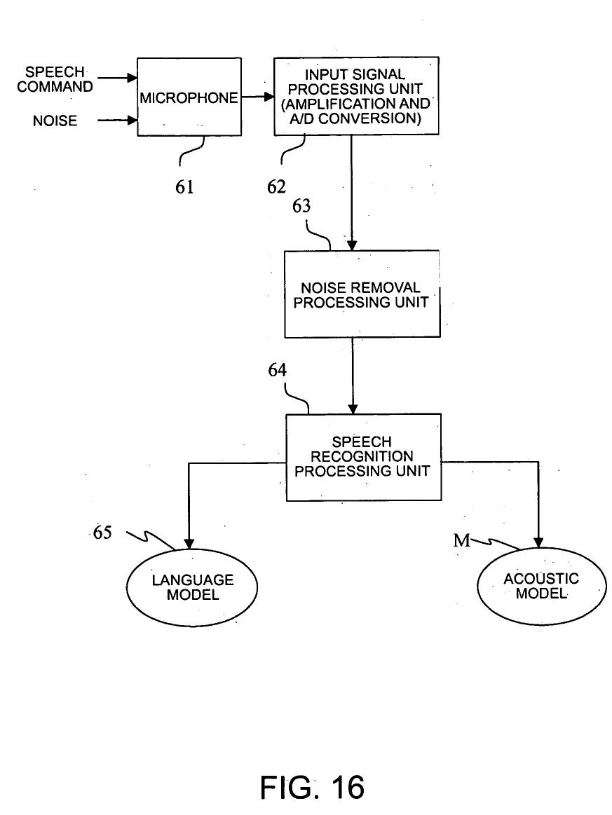

### DETAILED DESCRIPTION OF PREFERRED EMBODIMENTS

Now, the embodiments of the present invention will be described. In addition, the subject matter regarded as embodiments of the invention relates to an acoustic model creating method, a speech recognition apparatus, and a vehicle having the speech recognition apparatus.

In addition, in the embodiments of the present invention, a space where noise exists can include a vehicle and a factory. A first embodiment relates to the vehicle, and a second embodiment relates to the factory. Herein, although it is considered that the vehicle includes various transportations, such as an electric train, an airplane, a ship, and others, as well as a car and a two-wheeled vehicle, the present invention will be described for the car as an exemplary one.

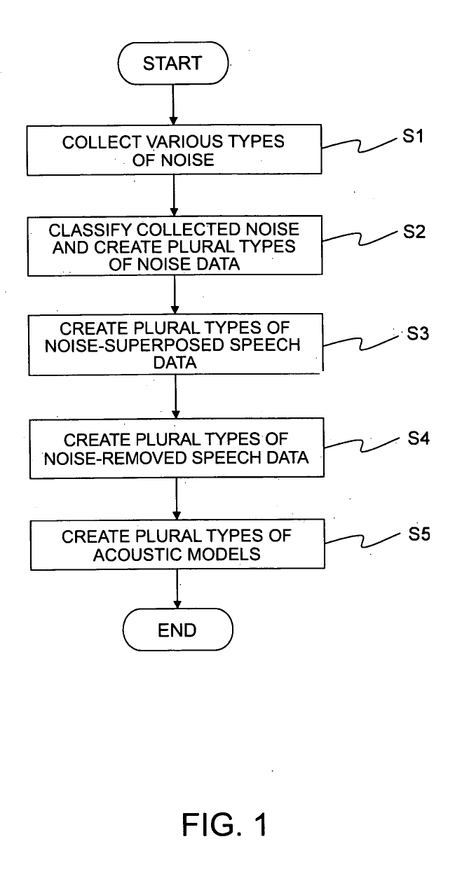

The schematic processing sequence of an acoustic model creating method for speech recognition will be simply described with reference to the flow chart shown in FIG. 1. This applies to the first embodiment and the second embodiment (which will be described in greater detail below) in common.

Various types of noise, which are collectable within the space having noise, are collected (Step 1). Then, plural types of noise data corresponding to plural types of noise groups are created by classifying the collected noise (Step 2). The plural types of noise data are superposed on the previously prepared standard speech data to create plural types of noise-superposed speech data (Step 3). Subsequently, a noise removal process is performed on the plural types of noise-superposed speech data to create plural types of noise-removed speech data (Step 4). Then, plural types of acoustic models are created from the plural types of noise-removed speech data (Step 5).

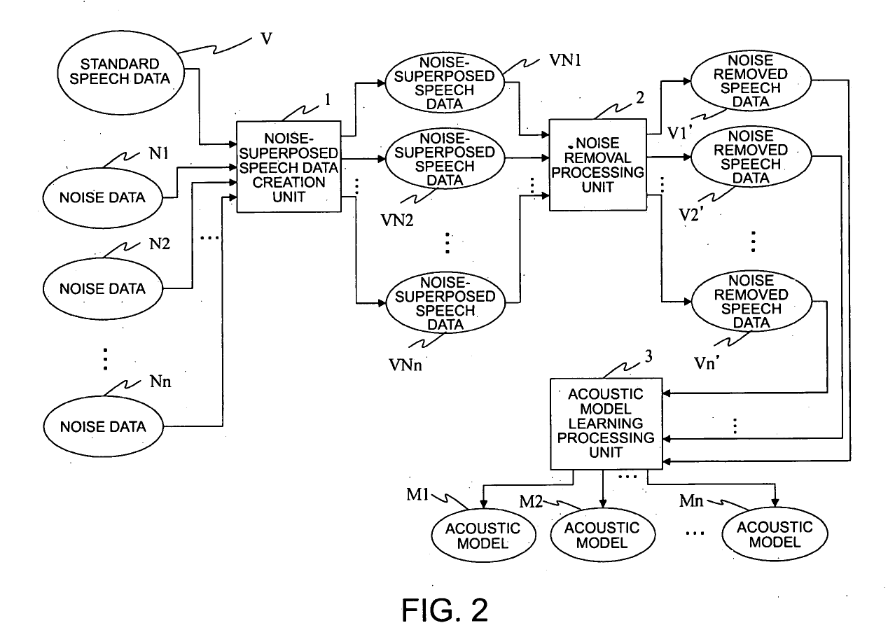

Now, the present invention will be described in details taking a car as an example. The processing sequence described in FIG. 1 will be described in detail with reference to FIG. 2.

In case of a car, most of the noise, which is input to the microphone for speech command input, is the car-unique noise, and thus the noise may be previously collected. Therefore, when the speech recognition is performed within the car, various types of the car-unique noise, which are likely to have an effect on the speech recognition performance, are collected. The collected various types of noise are classified by some statistical methods to create n noise groups. And then, noise data N1, N2, . . . , Nn are created corresponding to each of the noise groups (the detailed description thereon will be made below).

In addition, differences between S/N ratios are considered for the noise data N1, N2, . . . , Nn corresponding to each of the n noise groups (n types of noise data N1, N2, . . . , Nn). Namely, when the S/N ratio of one type of noise has a range from 0 dB to 20 dB, the noise is classified into n noise groups in accordance with the difference between the S/N ratios, and then, the n types of noise data N1, N2, . . . , Nn are created.

Subsequently, the standard speech data V (for example, a large amount of speech data which are obtained from plural words uttered by a number of speakers) are collected under the anechoic room and the like. The standard speech data V and the aforementioned n types of noise data N1, N2, . . . , Nn are inputted to a noise-supposed speech data creating unit 1, and then the standard speech data are superposed on the aforementioned n types of noise data N1, N2, . . . , Nn, respectively, and n types of noise-superposed speech data VN1, VN2, . . . , VNn are created.

Next, a noise removal processing unit 2 performs a noise removal process on the n types of the noise-superposed speech data VN1, VN2, . . . , VNn by using an optimal noise removal processing method to create n types of noise-removed speech data V1′, V2′, . . . , Vn′. Thereafter, an acoustic model learning processing unit 3 performs the learning of acoustic models using the n types of the noise-removed speech data V1′, V2′, . . . , Vn′ to create n types of acoustic models M1, M2, . . . , Mn.

In addition, in the optimal noise removal processing methods for each of the n types of the noise-superposed speech data VN1, VN2, . . . , VNn, the n types of noise removal process may be performed on each of the n types of the noise-superposed speech data VN1, VN2, . . . , VNn. In addition, several types of representative noise removal processing methods may be previously prepared, and then, an optimal noise removal processing method for each noise-superposed speech data may be selected from the noise removal processing methods and used.

The several types of the representative noise removal processing methods comprise the spectral subtraction method (SS method), the cepstrum mean normalization method (CMN method), and an echo cancel method by which the sound source is presumed. One optimal noise removal processing method for each noise may be selected from these noise removal processing methods to remove noise. Otherwise, two or more types of noise removal processing methods among the noise removal procedure methods may be combined, and each of the combined noise removal processing methods may be weighted to remove noise.

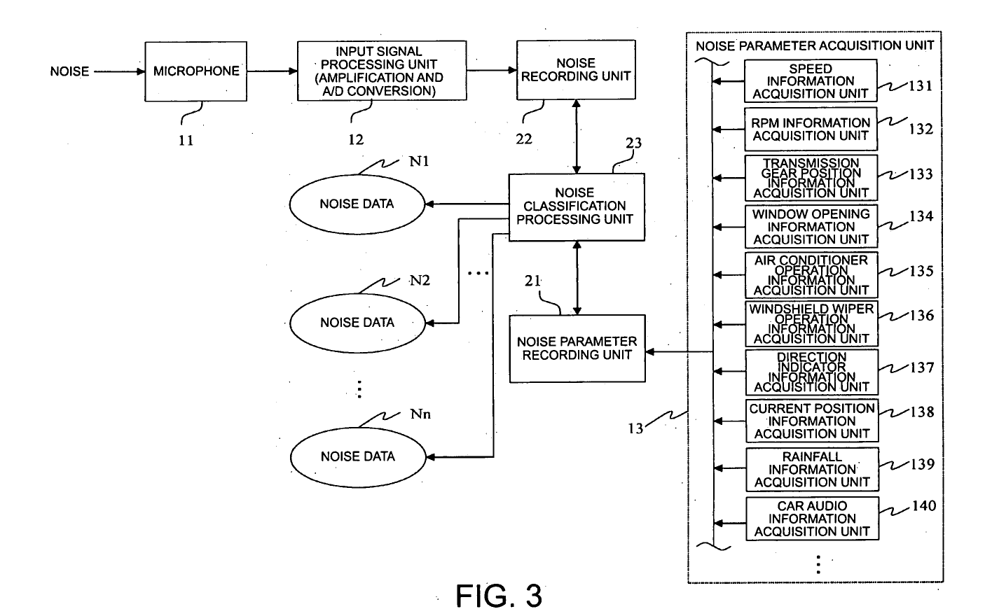

Next, a specific example, in which the collected various types of noise are classified into several (n) types by a statistical method, and n types of noise data N1, N2, . . . , Nn are generated for every noise group obtained by the classification, will be described in detail with reference to FIG. 3.

According to the first embodiment, the present invention is applied to recognize the speech commands for operating apparatuses mounted in the car. The car used for collecting noise is driven for a long time under various conditions, and the various types of car-unique noise are collected in time series from the microphone 11 that is provided at a predetermined location within the car.

In addition, when the driver operates the apparatuses using speech, it is preferable that the microphone 11 be provided at a location, where the speaker's speech commands are suitably inputted, within the car used for collecting noise.

For the microphone 11 in the for-sale car on which the speech recognition apparatus of the present invention is mounted, when the location of the microphone 11 is fixed, for example, to a steering wheel portion, the microphone 11 is provided at the fixed location to collect noise. Thereafter, the collected noise is amplified or A/D converted in an input signal processing unit 12, and then the resulting signals are recorded in a noise recording unit 22.

On the other hand, when the location of the microphone 11 is not determined in the design and development stages, a plurality of microphones 11 may be provided at the plural proposed locations to collect noise. In this embodiment, one microphone 11 is provided at a predetermined place to collect noise.

In addition to collection of noise by the microphone 11, information (sometimes called noise parameter) representing the traveling state of a vehicle, a current location, weather conditions (herein, referred to as rainfall) and the operation state of various apparatuses mounted in the vehicle is collected in time series.

The noise parameters includes information representing the speed of the car, information representing the RPM of the engine, information representing the position of the transmission gear, information representing the degree of opening of the windows, information representing the operational state of the air conditioner (setting state for the amount of wind therefrom), information representing the operational states of the windshield wipers, information representing the operational states of the direction indicators, information representing the rainfall indicated by a rain gauge, information of the traveling location provided by the GPS (Global Positioning System), information representing the sound signal of the car audio, and the like. Each of the noise parameters are acquired in time series by a noise parameter acquisition unit 13 capable of acquiring the noise parameters, and then recorded in a noise parameter recording unit 21.

In addition, the noise parameter acquisition unit 13 is provided in the car. For example, the noise parameter acquisition unit 13 can include a speed information acquisition unit 131 for acquiring the information representing the traveling speed of the car, a RPM information acquisition unit 132 for acquiring the information representing the RPM of the engine, a transmission gear position information acquisition unit 133 for acquiring the information representing the position of the transmission gear, a window opening information acquisition unit 134 for acquiring the information representing the degree of opening of the windows, such as opening 0%, opening 50%, and opening 100%, an air conditioner operation information acquisition unit 135 for acquiring the information representing the operational states of the air conditioner, such as stop and the amount of wind (a strong wind and a weak wind), a windshield wiper information acquisition unit 136 for acquiring the information representing on/off states of the windshield wipers, a direction indicator information acquisition unit 137 for acquiring the information representing on/off states of the direction indicators, a current location information acquisition unit 138 for acquiring the current location information from the GPS, a rainfall information acquisition unit 139 for acquiring the information representing the amount of rainfall (nothing, small amount, large amount and the like) from a rainfall sensor, and a car audio information acquisition unit 140 for acquiring the information representing the volume from the car audio.

In addition, as described above, noise data collected in time series by the microphone 11 and each of the noise parameters, which are acquired in time series from each of the information acquisition units 131 to 140 in the noise parameter acquisition unit 13, are obtained when actually driving the car (including the stop state).

Namely, the car is driven for a long time, such as one month or several months, at different locations and under different weather conditions, and each of the noise parameters vary under different conditions.

For example, the car is driven under different conditions in which the driving speed, the RPM of the engine, the position of the transmission gear, the degree of opening of the windows, the setting state of the air conditioner, the sound signal output from the car audio, and the operational states of the windshield wipers and the direction indicators vary in various manners.

By doing so, the various types of noise are input in time series into the microphone 11, and the input noise is amplified and A/D converted in the input signal processing unit 12. Then, the resulting signals are recorded, as the collected noise, in the noise recording unit 22, and each of the noise parameters is simultaneously acquired in time series in the noise parameter acquisition unit 13 to be recorded in the noise parameter recording unit 21.

In addition, a noise classification processing unit 23 classifies the collected noise and creates n noise groups through a statistical method using the time-series noise collected by the microphone 11 (the time-series noise recorded in the noise recording unit 22) and the noise parameters recorded in the parameter recording unit 21. Then, the noise data N1, N2, . . . , Nn are created for every noise group.

Several noise classification methods performed by the noise classification processing unit 23 exist. For example, in the one method, the feature vectors of the colleted time-series noise data are vector-quantized, and the noise data are classified into n noise groups based on the results of the vector quantization. In the other method, the noise data are actually superposed on the previously prepared several speech recognition data to perform speech recognition, and the noise data are classified into n noise groups based on the result of the recognition.

In addition, since each of the n types of the noise data N1, N2, . . . , Nn depends on the aforementioned various noise parameters, such as the information representing the driving speed, the information representing the RPM of the engine, the information representing the transmission gear, the information representing the degree of opening of the windows, the information representing the operational states of the air conditioner, each of the noise parameters and the n types of the noise data N1, N2, . . . , Nn correspond to each other.

For example, the noise data N1 is one of the noise data corresponding to a state in which the driving speed is in a range of 40 km/hr to 80 km/hr, the RPM is in a range of 1500 rpm to 3000 rpm, the transmission gear is at the top, the degree of opening of the windows is 0 (closed state), the air conditioner operates in the weak wind mode, the windshield wiper is in off state, and the like (the other noise parameters are omitted). The noise data N2 is one of the noise data corresponding to a state in which the driving speed is in a range of 80 km/hr to 100 km/hr, the RPM is in a range of 3000 rpm to 4000 rpm, the transmission gear is at the top, the degree of opening of the windows is 50% (half open state), the air conditioner operates in the strong wind mode, the windshield wiper is in off state, and the like (the other noise parameters are omitted).

Thus, when each of the noise parameters has a certain value at the current time, it can be known which noise data of the n types of noise data N1, N2, . . . , Nn includes the noise at that time. In addition, the specific examples for the n types of noise data N1, N2, Nn will be described in greater detail below.

By doing so, as shown in FIG. 2, if the n types of noise data N1, N2, . . . , Nn are created, these noise data N1, N2, . . . , Nn are superposed on the standard speech data V (a large amount of speech data, which are obtained from plural words uttered by a number of speakers, are collected in an anechoic room) to create the n types of the noise-superposed speech data VN1, VN2, . . . , VNn.

The noise removal process is performed on the n types of the noise-superposed speech data by a noise removal processing method suitable for removing each of the noise data N1, N2, . . . , Nn (as described above, by any one of the three types of noise removal process or the combination thereof in the first embodiment) to create the n types of the noise-removed speech data V1′, V2′, . . . , Vn′. And then, the acoustic modellearning is performed by the n types of the noise-removed speech data V1′, V2′, . . . , Vn′ to create the n types of the acoustic models M1, M2, . . . , Mn.

The n types of acoustic models M1, M2, . . . , Mn correspond to the n types of noise data N1, N2, . . . , Nn.

Namely, the acoustic model M1 is an acoustic model which is created from the speech data V1′ which is obtained by removing the noise data N1 from the speech data (the noise-superposed speech data VN1) on which the noise data N1 is superposed (the noise data N1 is not completely removed and their components remain), and the acoustic model M2 is an acoustic model which is created from the speech data which is obtained by removing the noise data N2 from the speech data on which the noise data N2 is superposed (the noise data N2 is not completely removed and their components remain).

In addition, the acoustic model Mn is an acoustic model which are created from the speech data Vn′ which are obtained by removing the noise data Nn from the speech data (the noise superposed speech data VNn) on which the noise data Nn are superposed (although the noise data Nn are not completely removed and their components remain).

By doing so, the acoustic models M1, M2, . . . , Mn are created to be used for performing speech recognition at the time of operating the apparatuses in the car using speech in the first embodiment of the present invention.

Next, a noise data classifying process (the noise collected by the microphone 11) performed when such acoustic models M1, M2, . . . , Mn are created will be described in detail.

The car is driven for a long time in order to collect various types of noise. For example, the colleted noise includes tire pattern noise (which is mainly related to the speed), engine sounds (which is mainly related to the speed, the RPM, and the gear position), wind roar at the time of the windows being opened, operational sounds of the air conditioner, sounds due to raindrops or an operational sound of the windshield wipers if it rains, operational sounds of the direction indicators at the time of the car changing the traveling direction, echo sounds generated at the time of the car passing through a tunnel, and sound signals, such as music, generated from a car audio.

All of these sounds may be collected as noise at a certain time, and only tire pattern noise or engine sounds of these sounds may be collected as noise. In addition to such noise, the noise parameters acquired at each time from various noise parameter acquisition units 13, which are provided in the car, are recorded.

Generally, various types of noise exist as described above. The microphone 11 collects noise corresponding to each of the noise parameters and various types of noise corresponding to plural combinations of the noise. And then, the classification process is performed to classify the noise obtained by the microphone 11 into the practical number of noise groups using a statistical method. However, in this embodiment, three types of noise parameters (the driving speed, the operational state of the air conditioner, and the amount of rainfall) are considered for simplicity of the description. The three types of noise parameters of the driving speed, the operational state of the air conditioner, and the amount of rainfall are represented by the values on three orthogonal axes in the three dimensional coordinate system (herein, the values which represent each state of three levels).

In this case, the speed is represented by three levels of “stop (speed 0)”, “low speed”, and “high speed”, the operational state of the air conditioner is represented by three levels of “stop”, “week wind”, and “strong wind”, and the amount of rainfall is represented by three levels of “nothing”, “small amount”, and “large amount”.

In addition, the speed levels of “low speed” and “high speed” are previously defined, for example, as up to 60 km/hr and above thereof, respectively. Similarly, the rainfall levels of “nothing”, “small amount”, and “large amount” are previously defined as the amount of rainfall of 0 mm per hour, the amount of rainfall of up to 5 mm per hour, and the amount of rainfall of above 5 mm per hour, respectively, which are obtained by the rain gauge.

In addition, the noise parameters representing the amount of rainfall (“nothing”, “small amount”, and “large amount”) may be obtained from the operational states of the windshield wipers, not the rain gauge. For example, when the windshield wiper is in an off state, the amount of rainfall is “nothing”. When the windshield wiper operates at a low speed, the amount of rainfall is “small amount”, and when the windshield wiper operates at a high speed, the amount of rainfall is “large amount”.

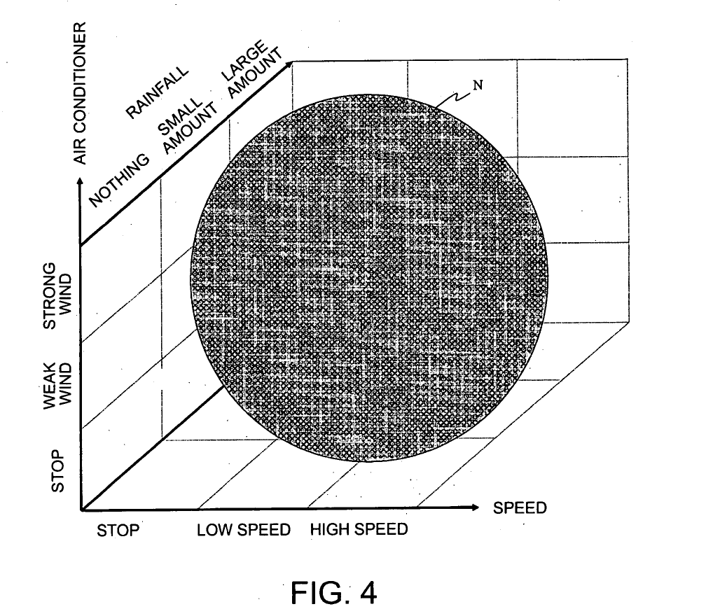

In FIG. 4, the collection objects are the noise comprising the aforementioned three types of noise parameters, and the noise data (represented by N), which are obtained by collecting the noise generated corresponding to the three types of noise parameters for a long time using the one microphone 11, are plotted as one large sphere. In FIG. 4, the speed is represented by three levels of “stop”, “low speed”, and “high speed”. The operational state of the air conditioner is represented by three levels of “stop”, “week wind”, and “strong wind”. Furthermore, the amount of rainfall is represented by three levels of “nothing”, “small amount”, and “large amount”. These noise parameters are plotted on the three dimensional coordinates.

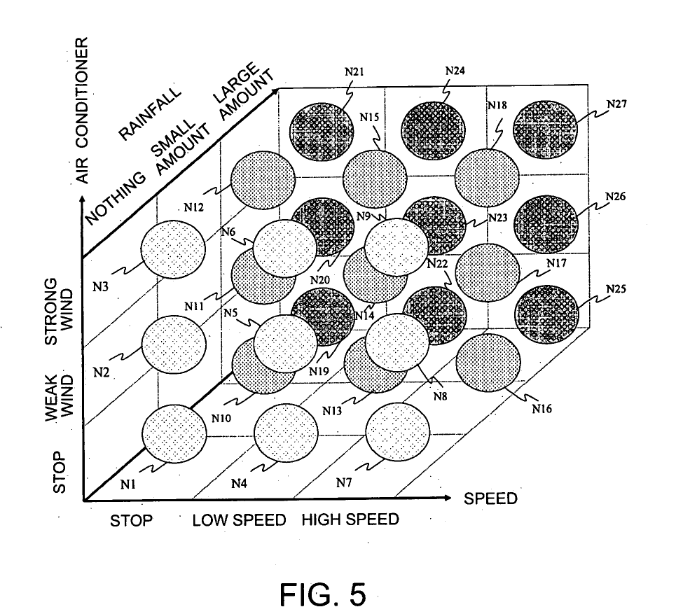

In FIG. 5, the noise data N are simply classified into every noise parameter without using the statistical method in which vector quantization is utilized. In this case, the third power of three, 27, noise groups are obtained, and 27 noise data N1 to N27 are obtained for every noise group. The 27 noise data N1 to N27 are represented by small spheres.

Referring to FIG. 5, several noise data will be described. For example, the noise data N1 is one of the noise data when speed is in the state of “stop (speed 0)”, the air conditioner is in the state of “stop”, and the amount of rainfall is “nothing”. The noise data N5 corresponds to one of the noise data when the speed is in the state of “low speed”, the air conditioner is in the state of “weak wind”, and the amount of rainfall is “nothing”. The noise data N27 corresponds to one of the noise data when the speed is in the state of “high speed”, the air conditioner is in the state of “strong wind”, and the amount of rainfall is “large amount”.

In addition, in FIG. 5, each of the noise parameters N1 to N27 is represented by the density of a color in accordance with the amount of rainfall of “nothing”, “small amount”, and “large amount”. The 3×3 noise data N1 to N9 corresponding to the case of the rainfall being “nothing” are represented by the most bright color; the 3×3 noise data N10 to N18 corresponding to the case of the rainfall being “small amount” are represented by the medium color; and the 3×3 noise data N19 to N27 corresponding to the case of the rainfall being “large amount” are represented by the most dark color.

According to FIG. 5, it is possible to accurately know which type of noise data are input to the microphone 11 according to the noise parameters at the current time in the car. As a result, it is possible to perform speech recognition using the optimal acoustic models. For example, if the current speed of the car is “low speed”, the air conditioner is in the state of “week wind”, and the amount of rainfall is in the state of “nothing”, then the noise data is N5 at that time. Thus, the speech recognition can be performed by the acoustic model corresponding to the noise data N5.

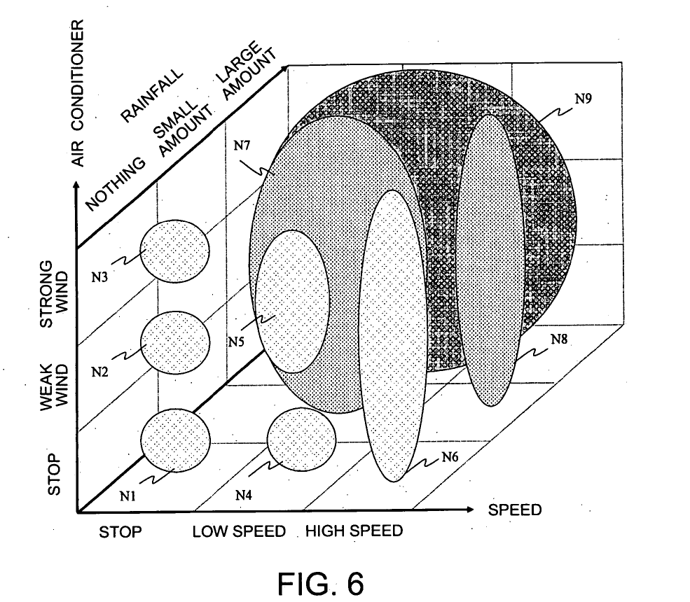

Referring to FIG. 5, although the time-series noise data obtained from the microphone 11 are classified into each of the numbers of the circumstances (in this example, there are 27 different types of circumstances) in which each of the noise parameters can be simply taken, another example in which the time-series noise data are classified by a statistical method will be described with reference to FIG. 6.

Furthermore, in the example for performing classification using a statistical method, there are some methods. In one method, as described above, the feature vectors corresponding to each time of the noise data are vector-quantized, and classified into plural noise groups based on the results of the vector quantization. In another method, noise data are actually superposed on the previously prepared several speech recognition data to perform speech recognition, and then the noise data are classified into n noise groups according to the result of the recognition.

As a result of the classification in accordance with such methods, 9 noise groups are created, and 9 types of noise data N1 to N9 are created corresponding to each of the 9 noise groups, as shown in FIG. 6.

In FIG. 6, the rainfall sound has the greatest effect on the speech recognition, followed by the driving speed of the car. The air conditioner has the lower effect on the speech recognition as compared to the rainfall sound or the driving speed.

In FIG. 6, when the amount of rainfall is “nothing” and the driving speed of the car is 0 (“stop”), the noise data N1, N2, N3 are created corresponding to the operational states of the air conditioner. When the amount of rainfall is “nothing” and the driving speed of the car is “low speed”, the noise data N4 corresponding to the operational state “stop” of the air conditioner is created, and noise data N5 corresponding to the operational states “weak wind” and “strong wind” of the air conditioner is created. Namely, when the car is driven at a predetermined speed, it is determined that the operational sound of the air conditioner which is even in the state of “weak wind” and “strong wind” has almost no effect on speech recognition as compared to the noise due to the traveling of the car. In addition, when the speed of the car is “high speed”, noise data N6 is created regardless of the operational state of the air conditioner.

Furthermore, when it rains, the noise data depending on the driving speed of the car are created regardless of the operational sates of the air conditioner even if the amount of rainfall is “small amount”. That is, when the amount of rainfall is “small amount”, two types of noise groups including the noise data N7, which corresponds to the “low speed” (including “stop”), and the noise data N8, which corresponds to “high speed”, are created. In addition, when the amount of rainfall is “large amount”, the operational state of the air conditioner and the driving speed of the car have almost no effects on speech recognition, and then noise data N9 is created.

As described above, the collection objects are the noise corresponding to the three types of the noise parameters (the driving speed, the operational state, and the amount of rainfall). The noise data N, which are obtained by collecting the noise depending on the three types of noise parameters for a long time using the one microphone 11, are classified by a statistical method. As a result, the noise data N1 to N9 are created as shown in FIG. 6.

In addition, in the noise data N1 to N9 obtained from FIG. 6, the three noise parameters of the driving speed, the operational state, and the amount of rainfall are exemplified for simplicity of the description, but actually there exist various types of noise parameters as described above. Therefore, various types of noise depending on the various types of noise parameters are collected for a long time to obtain the time-series data. The time-series data are classified by a statistical method to obtain n noise groups, and then the n types of noise data N1 to Nn corresponding to each noise group are created.

Furthermore, it is preferable that the practical numbers of the noise groups be from several to over tens in consideration of the efficiencies of the acoustic model creating process and the speech recognition process. However, the number may be changed arbitrarily.

By doing so, if the n types of noise data N1, N2, . . . , Nn are created corresponding to the n noise groups, the n types of noise data N1, N2, . . . , Nn are superposed on the standard speech data to create the n noise-superposed speech data VN1, VN2, . . . , VNn as described above (see FIG. 1). The noise removal process is performed on the n types of noise-superposed speech data VN1, VN2, . . . , VNn using the optimal noise removal process suitable for removing each of the noise data, and then the n types of the noise-removed speech data V1′, V2′, . . . , Vn′ are created.

The acoustic model learning is performed using the n types of the noise-removed speech data V1′, V2′, . . . , Vn′ to create the n types of the acoustic models M1, M2, . . . , Mn. Thus, the n types of the acoustic models M1, M2, . . . , Mn corresponding to the n types of the noise data N1, N2, . . . , Nn can be created.

Next, the speech recognition using the n types of acoustic models M1, M2, . . . , Mn which are created by the aforementioned processes will be described.

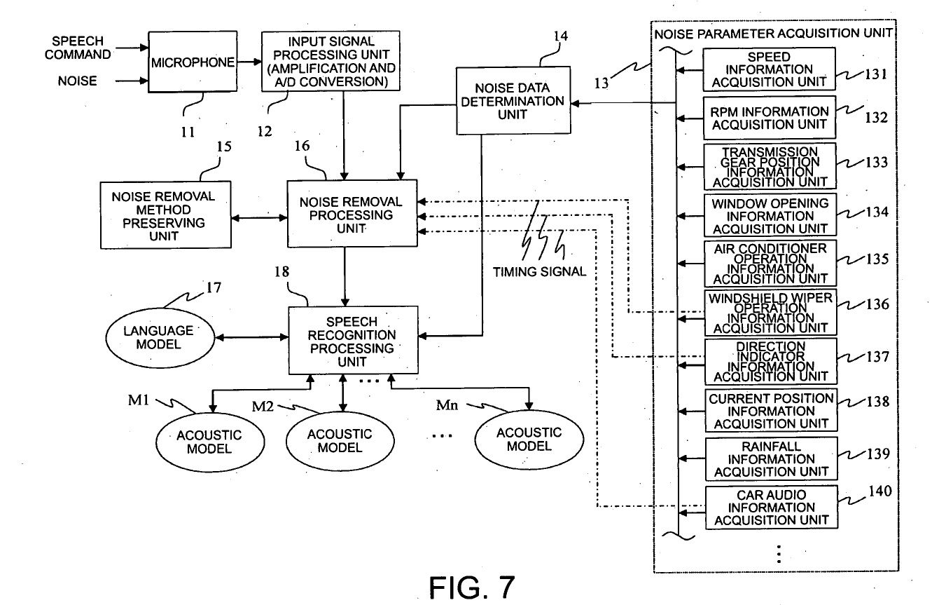

FIG. 7 is a structural view illustrating an exemplary speech recognition apparatus of the present invention. The speech recognition apparatus comprises a microphone 11 which is sound input device for inputting sound commands for operating apparatuses or various types of noise, an input signal processing unit 12 for amplifying the speech commands inputted from the microphone 11 and for converting the speech commands into digital signals (A/D converting), a noise parameter acquisition unit 13 for acquiring the aforementioned various noise parameters, a noise data determination unit 14 for determining which type of noise data of the n types of noise data N1, N2, . . . , Nn, which are created by the aforementioned classification process, corresponds to the current noise based on the various noise parameters acquired from the noise parameter acquisition unit 13, a noise removal method preserving unit 15 for preserving optimal noise removal methods for each of the noise data N1, N2, . . . , Nn, a noise removal processing unit 16 for selecting the optimal noise removal method for the noise data determined by the noise data determination unit 14 from the various noise removal methods preserved in the noise removal method preserving unit 15 and for performing the noise removal process on the speech data (the noise-superposed speech data after the digital conversion) inputted from the microphone 11, and a speech recognition processing unit 18 for performing speech recognition on the noise-superposed speech data, from which noise has been removed by the noise removal processing unit 16, using any one of the acoustic models M1 to Mn (corresponding to the n types of noise data N1, N2, . . . , Nn), which are created by the aforementioned method, and a language model 17.

The speech recognition apparatus shown in FIG. 7 can be provided at a suitable location within a vehicle (car in the first embodiment).

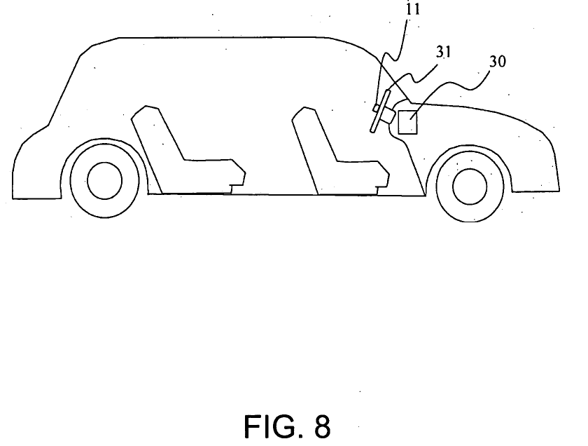

FIG. 8 illustrates an example of a vehicle (car in the example of FIG. 8) in which the speech recognition apparatus (represented by the reference numeral 30 in FIG. 8) shown in FIG. 7 is provided. The speech recognition apparatus 30 can be mounted at an appropriate location within the car. In addition, it should be understood that the mounting location of the speech recognition apparatus 30 is not limited to the example of FIG. 8, but appropriate locations, such as a space between the seat and floor, a trunk, and others, may be selected. Furthermore, the microphone 11 of the speech recognition apparatus 30 can be provided at a location where the driver's speech can be easily inputted. For example, the microphone 11 may be provided to the steering wheel 31. However, it should be understood that the location of the microphone 11 is not limited to the steering wheel 31.

On the other hand, the noise data determination unit 14 shown in FIG. 7 receives various noise parameters from the noise parameter acquisition unit 13, and determines which noise data of the plural types of noise data N1 to N9 corresponds to the current noise.

Namely, the noise data determination unit 14 determines which noise data of the noise data N1 to N9 corresponds to the current noise based on the noise parameters from the noise parameter acquisition unit 13, such as the information representing the speed from the speed information acquisition unit 131, the information representing the operational state of the air conditioner from the air conditioner operation information acquisition unit 135, and the information representing the amount of rainfall from the rainfall information acquisition unit 139, as described above.

For example, if the noise data determination unit 14 receives as the noise parameters the information in which the current driving speed is 70 km, the operational state of the air conditioner is “weak wind”, and the amount of rainfall is “nothing”, the noise data determination unit 14 determines from the noise parameters which noise data of the plural types of the noise data N1 to N9 corresponds to the current noise. When it is determined that the current noise belongs to the noise data N6, the results of the determination are transmitted to the noise removal processing unit 16 and the speech recognition processing unit 18.

If the noise removal processing unit 16 receives the information representing the type of the current noise from the noise data determination unit 14, the noise removal processing unit 16 performs the noise removal process using the optimal noise removal method for the noise-superposed speech data from the input signal processing unit 12. For example, if the information representing that the current noise belongs to the noise data N6 is transmitted from the noise data determination unit 14 to the noise removal processing unit 16, the noise removal processing unit 16 selects the optimal noise removal method for the noise data N6 from the noise removal method preserving unit 15 and performs the noise removal process on the noise-superposed speech data using the selected noise removal method.

In addition, according to this embodiment, the noise removal process is performed using, for example, either the spectral subtraction method (SS method) or the cepstrum mean normalization method (CMN method), or the combination thereof, as described above.

Furthermore, when the current noise includes the sound signals from the car audio, the operational sounds of the windshield wipers, and the operational sounds of the direction indicator, it is possible to perform a process for removing such noise directly.

For example, with respect to the sound signals from the car audio which are included in the noise-superposed speech data inputted into the microphone 11, the sound signals directly obtained from the car audio, that is, the car audio signals obtained from the car audio information acquisition unit 140 are supplied to the noise removal processing unit 16 (as represented by dash-dot line in FIG. 7), and the sound signal components, which are included in the noise-superposed speech data inputted into the microphone 11, can be removed by subtracting the car audio signals from the noise-superposed speech data inputted into the microphone 11. At this time, in the noise removal processing unit 16, since the car audio signals, which are included in the noise-superposed speech data inputted into the microphone 11, have a certain time delay in comparison to the sound signals directly obtained from the car audio, the removal process is performed in consideration to the time delay.

Furthermore, the operational sounds of the windshield wipers or the direction indicators are periodic operational sounds, and each period and noise components (operational sounds) are determined in accordance with the type of the car. Thus, the timing signals (as represented by dash-dot line in FIG. 7) corresponding to each period are transmitted from the windshield wiper information acquisition unit 136 or the direction indicator acquisition unit 137 to the noise removal processing unit 16. Then, the noise removal processing unit 16 can remove the operational sounds of the windshield wipers or the operational sounds of the direction indicators at the timing. Even in the case, since the operational sounds of the windshield wipers or the operational sounds of the direction indicators, which are included in the noise-superposed speech data inputted from the microphone 11, have a certain time delay in comparison to the operational signals directly obtained from the windshield wipers or the direction indicators, the noise removal process is performed at the timing for which the time delay is considered.

As described above, if the noise removal process is performed on the noise-superposed speech data (including speech commands and the noise inputted into the microphone at that time) obtained from the microphone 11 at a certain time, the noise-removed speech data from which noise is removed are transmitted to the speech recognition processing unit 18.

Information representing any one of the noise data N1 to N9 as the results of the noise data determination from the noise data determination unit 14 is supplied to the speech recognition processing unit 18. The acoustic model corresponding to the result of the noise data determination is selected. The speech recognition process is performed using the selected acoustic model and the language model 17. For example, if the information representing that the noise, which is superposed on the speaker's speech commands inputted into the microphone 11, belongs to the noise data N1 is transmitted from the noise data determination unit 14 to the speech recognition processing unit 18, the speech recognition processing unit 18 selects the acoustic model M1 corresponding to the noise data N1 as an acoustic model.

As described in the aforementioned acoustic model creating method, the noise data N1 is superposed on the speech data, and the noise is removed from the noise-superposed speech data to create the noise-removed speech data. Then, the acoustic model M1 is created from the noise-removed speech data. Thus, when the noise superposed on the speaker's speech commands belongs to the noise data N1, the acoustic model M1 is most suitable for the speaker's speech commands. Therefore, it is possible to increase the recognition performance.

As one specific example, the speech recognition operation in which 9 types of noise data N1 to N9 corresponding to 9 noise groups are created and acoustic models M1 to M9 corresponding to the 9 types of the noise data N1 to N9 are created as shown in FIG. 6 will be described.

Herein, an example, in which when a driver instructs the speech commands during the operation, the speech recognition apparatus 30 recognizes the speech commands, and the operation of the apparatus is performed based on the results of the recognition, is described. Furthermore, at this time, it is assumed that the driving speed is 40 km/hr (referred to as low-speed traveling), the operational state of the air conditioner is “week wind”, and the amount of rainfall is “nothing”.

In this case, the noise corresponding to each circumstance is input into the microphone 11 that is provided at a certain location within the car (for example, steering wheel). If the speaker utters a certain speech command, the noise corresponding to each circumstance is superposed on the speech command. The noise-superposed speech data are amplified or A/D converted in the input signal processing unit 12, and then the resulting signals are transmitted to the noise removal processing unit 16.

On the other hand, in this case, the information representing the current driving speed from the speed information acquisition unit 131, the information representing the operational states of the air conditioner from the air conditioner operation information acquisition unit 135, and the information representing the amount of rainfall from the rainfall information acquisition unit 139 are supplied as noise parameters to the noise data determination unit 14. The speed information acquisition unit 131, the air conditioner operation information acquisition unit 135, and the rainfall information acquisition unit 139 are included in the noise parameter acquisition unit 13. The noise data determination unit 14 determines which noise data of the noise data N1 to N9 corresponds to the current noise based on the noise parameters.

In this case, the information representing the driving speed is 40 km/hr (herein, referred to as “low speed”). The information representing the operational states of the air conditioner is “low speed”. The information representing the amount of rainfall is “nothing”. Therefore, the noise data determination unit 14 determines that the current noise is the noise data N5 from the noise data shown in FIG. 6 and transmits the result of the determination to the noise removal processing unit 16 and the speech recognition processing unit 18. By doing so, in the noise removal processing unit 16, the noise removal process is performed on the noise data N5 using the optimal noise removal processing method, and the noise-removed speech data are transmitted to the speech recognition processing unit 18.

In the speech recognition processing unit 18, the acoustic model M5 (not shown in FIG. 7) corresponding to the noise data N5 which are transmitted from the noise data determination unit 14 is selected, and the speech recognition process is performed on the noise-removed speech data, whose noise has been removed in the noise removal processing unit 16, using the acoustic model M5 and the language model 17. And then, the operation of apparatuses is performed based on the results of the speech recognition. An example of the operation of the apparatuses is to set the destination into the navigation system.

As described above, in the speech recognition apparatus of the first embodiment, it is determined which noise data of the noise data N1 to N9 corresponds to the noise superposed on the speech commands, the noise removal is performed using a noise removal processing method corresponding to the noise data (the same noise removal processing method as is used in the acoustic model creation), and then the speech recognition is performed on the speech data (the noise-removed speech data), from which noise is removed, using the optimal acoustic model.

Namely, even if the various types of noise, which correspond to the traveling state of the vehicle, the traveling location of the vehicle, and the operational state of the apparatus mounted in the car at a certain time, are superposed on the speech commands, the noise is removed by the optimal noise removal method corresponding to the noise. Thus, the speech recognition can be performed on the speech data from which noise has been removed using the optimal acoustic model, so that it is possible to obtain high recognition performance under various noise environments.

Particularly, the first embodiment is particularly effective in a case where types of vehicle are limited. That is, if the type of the vehicle for collecting noise, in which the acoustic models are created by the noise collection, is the same as the type of the for-sale vehicle on which the speech recognition apparatuses of the present invention is mounted, since the noise is input into the microphone under the almost same conditions by equalizing the mounting position of the microphone for collecting the noise in the vehicle for noise collection with the mounting position of the microphone for speech command input in the for-sale vehicle. Thus, the appropriate acoustic model can be selected, thereby obtaining high recognition performance.

In addition, a car exclusively used in collecting noise may be used for creating acoustic models. However, the speech recognition apparatus 30 and an acoustic model creating function (including the creation of the noise data N1 to Nn as shown in FIG. 3) are mounted together on the for-sale vehicle, so that it is possible to perform both the acoustic model creating function and the speech recognition function using only one vehicle. In this case, the microphone 11, the input signal processing unit 12, the noise parameter acquisition unit 13, the noise removal processing unit 16, and the like are used in common both when creating acoustic models and when performing speech recognition.

As described above, since the for-sale vehicle may have both the acoustic model creating function and the speech recognition function, it is possible to easily classify the noise corresponding to the fluctuation of a noise environment. Therefore, the acoustic models can be newly created and updated, so that it is possible to easily cope with the fluctuation of a noise environment.

In the second embodiment, a workshop of a factory is exemplified as a space where noise exists. For example, a situation in which the record of the result of inspection of products carried by belt conveyer is inputted by speech, the speech is recognized, and then the recognition result is stored as the inspection record, will be considered.

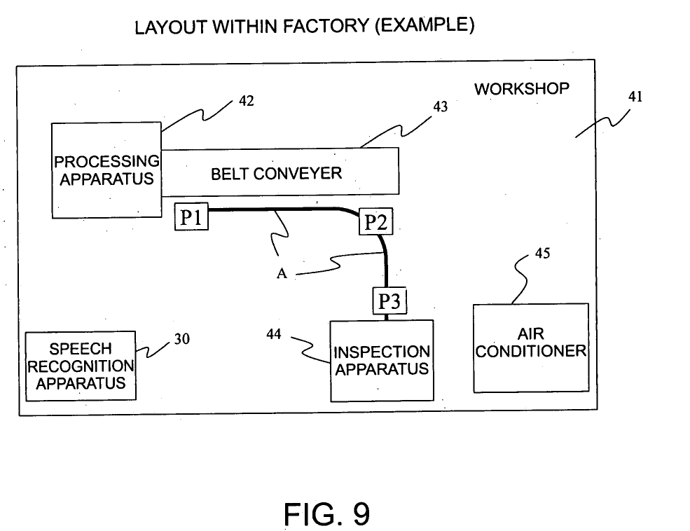

FIG. 9 illustrates a workshop in a factory. In the workshop 41, a processing apparatus 42 for processing products, a belt conveyer 43 for carrying the products processed by the processing apparatus 42, an inspection apparatus 44 for inspecting the products carried by the belt conveyer 43, an air conditioner 45 for controlling temperature or humidity in the workshop 41, and a speech recognition apparatus 30 of the present invention for recognizing worker's speech (not shown) are provided as shown in FIG. 9.

In addition, P1, P2, and P3 are positions where worker (not shown) conducts some operations and the worker's speech is inputted. That is, the worker conducts some operations at the position P1, and then moves to the position P2 to conduct other operations. And then, the worker moves to the position P3 to inspect products using the inspection apparatus 44. In FIG. 9, the solid line A indicates a moving line of the worker (hereinafter, referred to as moving line A).

In addition, at the positions P1 and P2, the worker inputs the check results for the checking items with respect to the products, which are come out from the processing apparatus 42, at each of the positions P1 and P2 using speech. At the position P3, the worker inspects the products using the inspection apparatus 44, and the inspection results are inputted by the worker's speech.

Furthermore, the worker has a headset microphone, and the speech input from the microphone is transmitted to the speech recognition apparatus 30. In addition, the check results or inspection results speech-recognized at each of the positions P1, P2, P3 by the speech recognition apparatus 30 are recorded on recording device (not shown in FIG. 9).

In order to perform the speech recognition at the workshop 41, it is necessary to consider the noise peculiar to the workshop 41. The noise can be previously collected similar to the car as described in the aforementioned first embodiment.

Therefore, when the speech recognition is performed in the workshop 41, the various types of noise peculiar to the workshop 41, which are likely to have an effect on the speech recognition performance, are collected. Similar to the aforementioned first embodiment as described with reference to FIG. 2, the collected various types of noise are classified to create n noise groups, and the noise data N1, N2, . . . , Nn (n types of noise data N1, N2, . . . , Nn) for each of the noise groups are created.

And then, the standard speech data V, which are collected under such an anechoic room (for example, a large amount of speech data which are obtained from plural words uttered by a number of speakers), and the aforementioned n types of noise data N1, N2, . . . , Nn are supplied to the noise-superposed speech data creating unit 1. Then, the standard speech data V are superposed on the aforementioned n types of the noise data N1, N2, . . . , Nn to create the n types of noise-superposed speech data VN1, VN2, . . . , VNn.

And then, a noise removal processing unit 2 performs a noise removal process on the n types of noise-superposed speech data VN1, VN2, . . . , VNn using an optimal noise removal processing method to create n types of noise-removed speech data V1′, V2′, . . . , Vn′. Thereafter, an acoustic model learning processing unit 3 learns acoustic models using the n types of noise-removed speech data V1′, V2′,. . . , Vn′ to create n types of acoustic models M1, M2, . . . , Mn.

In addition, the optimal noise removal processing method for each of the n types of the noise-superposed speech data VN1, VN2, . . . , VNn, can be considered the same as described in the first embodiment.

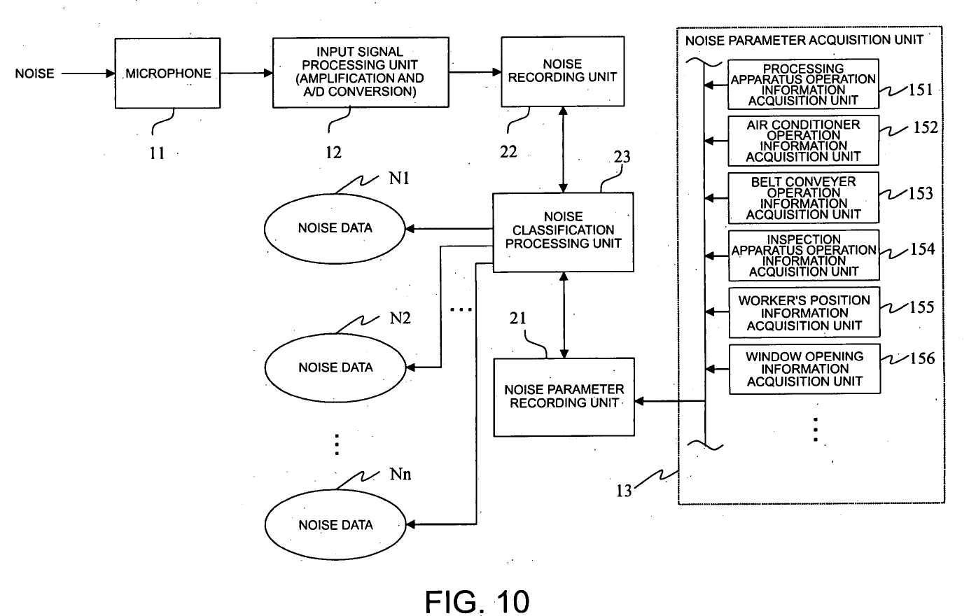

Next, the collected various types of noise are classified into n types, and a specific example for generating the noise data N1, N2, . . . , Nn for each of the noise groups obtained by the classification will be described in detail with reference to FIG. 10.

In the second embodiment, the noise collection can be performed for a predetermined time under a condition where the processing apparatus 42, the belt conveyer 43, the inspection apparatus 44, the air conditioner 45, etc., which are normally used in the workshop 41, are operated in ordinary working condition. In such noise collection, the worker has, for example, the headset equipped with the microphone, and the various types of noise data peculiar to the workshop are collected in time series for an predetermined time period through the microphone 11.

In addition, at this time, various types of noise are input into the microphone 11 mounted on the headset while the worker conducts his own actual operations.

In the second embodiment, as shown in FIG. 9, since the worker conducts operations with moving along the moving line A in the workshop 41, the noise collection is performed while the positions of the worker along the moving line A are input in accordance with the movement of the worker. In addition, in the case where the worker conducts operations at only the predetermined positions, the noise collection may be performed under a condition where the microphone 11 is provided at the positions. Furthermore, while the noise is collected from the microphone 11, the noise parameters as information representing the operational states of the apparatuses, which are the source of noise in the workshop 41, are acquired in time series at the noise parameter acquisition unit 13.

In the second embodiment, the acquired noise parameters include the information representing the operational states of the processing apparatus 42 (referred to as operational speed), the information representing the operational states of the air conditioner 45 (referred to as the amount of wind), the information representing the operational states of the belt conveyer 43 (referred to as operational speed), the information representing the operational states of the inspection apparatus 44 (for example, referred to as the information representing the types of the inspection methods in the case where plural inspection methods of the inspection apparatus 44 exist, and thus the sounds generated from the inspection apparatus 44 are different from each other in accordance with the types of the inspection methods), the position of the worker (for example, the one-dimensional coordinates along the moving line A as shown in FIG. 9, the two-dimensional coordinates on the floor in the workshop 41, or the discrete values of P1, P2, and P3 as shown in FIG. 9), the closed/open states of the windows or the doors provided in the workshop (referred to as the degree of opening of the windows or doors), the presence or the contents of the broadcast in the workshop, the condition of the baggage.

In addition, the noise parameter acquisition unit 13 is provided in the workshop 41. As described above, in order to acquire various noise parameters, the noise parameter acquisition unit 13 can include, for example, a processing apparatus operation information acquisition unit 151 for acquiring the information representing how fast the processing apparatus 42 is operated, an air conditioner operation information acquisition unit 152 for acquiring the information representing the operational state of the air conditioner 45, a belt conveyer operation information acquisition unit 153 for acquiring the information representing how fast the belt conveyer 43 is operated, an inspection apparatus information acquisition unit 154 for acquiring the operational information of the inspection apparatus 44, a worker position information acquisition unit 155 for acquiring the position information representing which position the worker is currently located at, and a window opening information acquisition unit 156 for acquiring the information representing the degree of opening of the windows. Besides the aforementioned information, various noise parameters to be acquired are considered, but the description thereof is omitted.

In addition, the noise, which are collected in time series by the microphone 11, and each of the noise parameters, which are acquired in time series by each of the information acquisition units 151 to 156 in the noise parameter acquisition unit 13, are obtained by the worker actually conducting operations in the workshop 41.

Namely, in order to obtain the noise that is likely to be generated at the workshop 41, for example, for one month, various types of noise which are generated in the workshop 41 are made by changing the operational states of the apparatuses, such as the processing apparatus 42, the belt conveyer 43, the inspection apparatus 44, and the air conditioner 45, and by changing the degree of opening of the windows.

By doing so, the various types of noise are input in time series into the microphone 11. The amplification process or the conversion process to digital signals (A/D conversion) is performed in the input signal processing unit 12. Then, the collected noise is recorded in the noise recording unit 22 while each of the noise parameters at the same time is acquired in time series in the noise parameter acquisition unit 13 to be recorded in the noise parameter recording unit 21.

In addition, a noise classification processing unit 23 classifies the collected noise by a statistical method using the time-series noise collected by the microphone 11 (the time-series noise recorded in the noise recording unit 22) and the noise parameters recorded in the noise parameter recording unit 21 to create n noise groups. Then, the noise data N1, N2, . . . , Nn are created for each of the noise groups.

Naturally, there are various types of the noise as described above. The noise corresponding to each of the noise parameters and various types of noise corresponding to plural combinations of the noise parameters are collected from the microphone 11. And then, the classification process is performed to classify the noise collected from the microphone 11 into practical number of noise groups by a statistical method. However, an example in which only three types of noise parameters (the position of the worker, the operational state of the processing apparatus 42, and the operational state of the air conditioner 45) are considered for simplicity of the description will be described. The three types of noise parameters of the position of the worker, the operational state of the processing apparatus 42, and the operational state of the air conditioner 45 are classified and represented by the values on three perpendicular axes in the three dimensional coordinate system (herein, values representing the states of three levels respectively).

Namely, the positions of worker are represented by the three positions P1, P2, P3 shown in FIG. 9. In this case, the operational states of the processing apparatus 42 are represented as three levels of “stop”, “low speed”, and “high speed”. The operational states of the air conditioner are represented as three levels of “stop”, “weak wind”, and “strong wind”.

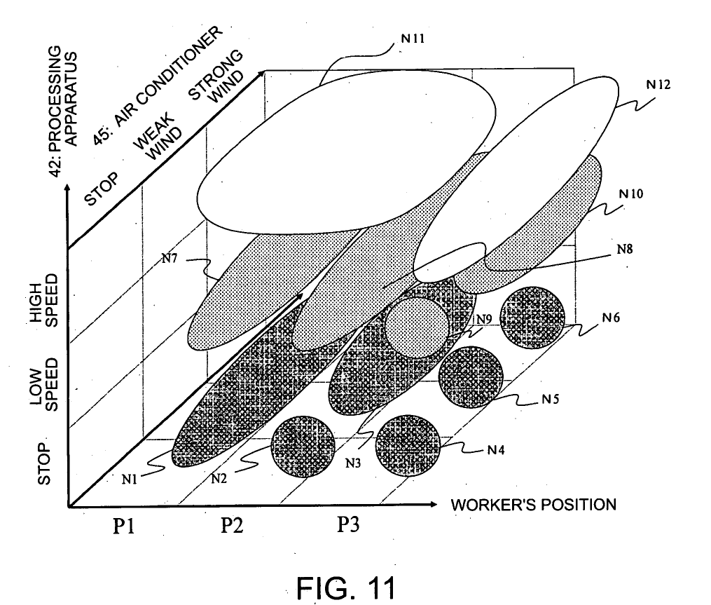

FIG. 11 illustrates an example of the result of the classification process. The one classification process which is similar to the classification process (the classification process from the state of FIG. 4 to the state of FIG. 5, which are used for the description of the first embodiment) of the aforementioned first embodiment is performed on the noise corresponding to the aforementioned three types of the noise parameters. And then, the other classification process (the classification process from the state of FIG. 5 to the state of FIG. 6, which are used for the description of the first embodiment) is also performed by a statistical method.

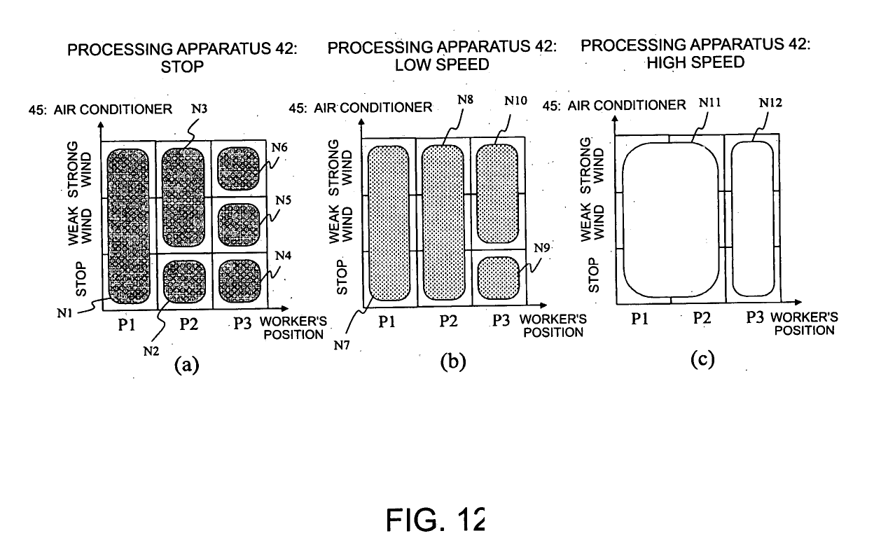

In FIG. 11, the twelve types of the noise data N1 to N12 corresponding to each of the noise groups are plotted on the three dimensional coordinate system. FIGS. 12(a) to 12(c) illustrate the two dimensional section of each of the three operational states of the processing apparatus, namely, “stop”, “low speed”, and “high speed” with respect to the twelve types of the noise data N1 to N12 on the three dimensional coordinate system.

FIG. 12(a) corresponds to a case of the processing apparatus 42 being in the state of “stop”. In this case, the noise parameters N1, N2, N3, N4, N5, and N6 on which the air conditioner 45 has an effect are created in accordance with the positions P1, P2, and P3 of the worker.

Namely, at the position P1 where the worker is far away from the air conditioner 45, one noise data N1 is created regardless of the operational states (“stop”, “weak wind”, and “strong wind”) of the air conditioner 45. At the position P2 of the worker, the noise data N2 and N3 are created in accordance with whether the operational state of the air conditioner 45 is “stop” or not, respectively. In addition, if the state is “stop”, the noise data N2 is created, and if the state is any one of the states “weak wind” and “strong wind”, the one noise data N3 are created.

Furthermore, at the position P3 of the worker, if the operational state of the air conditioner 45 is “stop”, the noise data N4 is created, if the operational state of the air conditioner 45 is “weak wind”, the noise data N5 is created, and if the operational state of the air conditioner 45 is “strong wind”, the noise data N6 is created. Thus, the noise data corresponding to each of the operational states of the air conditioner 45 are created.

It means that when the processing apparatus 42 is stopped, the operational state of the air conditioner 45 has a great effect on the noise at the positions P1, P2, and P3 of the worker, and such effects are different among the positions P1, P2, and P3.

In addition, FIG. 12(b) illustrates a case of the processing apparatus 42 being in the state of “low speed”. In this case, the noise data N7, N8, N9, and N10 on which the effect of the processing apparatus 42 are reflected are created in accordance with the positions P1, P2, and P3.

Namely, at the position P1 of the worker, the noise data N7 is created regardless of the operational states (“stop”, “weak wind”, and “strong wind”) of the air conditioner 45. At the position P2 of the worker, the noise data N8 is created regardless of the operational states (“stop”, “weak wind”, and “strong wind”) of the air conditioner 45. In addition, at the position P3 of the worker, if the operational state of the air conditioner 45 is “stop”, the noise data N9 is created, and if the operational state of the air conditioner is “weak wind” and “strong wind”, the noise data N10 is created.

FIG. 12(c) corresponds to a case of the processing apparatus 42 being in the state of “high speed”. In this case, the noise data NI1 and N12 on which the processing apparatus 42 has an effect are created.

Namely, even at any one of the positions P1, P2 of the worker, the one noise data N11 is created irrespective of the operational states (“stop”, “weak wind”, and “strong wind”) of the air conditioner 45. In addition, at the position P3 where the worker is close to the air conditioner 45, although the effect of the air conditioner 45 is somewhat reflected, the noise data N12 is created irrespective of the operational states (“stop”, “weak wind”, and “strong wind”) of the air conditioner 45.

As shown in FIG. 12, there is a tendency that when the operation of processing apparatus 42 is stopped, the operational sounds of the air conditioner 45 have great effects on the noise at the positions P1, P2, and P3 of the worker in accordance with each of the positions P1, P2, and P3, and during the operation of the processing apparatus 42, although the effect of the air conditioner 45 is also somewhat reflected in accordance with the positions, the operational sounds of the processing apparatus 42 dominate the whole noise.

As described above, the noise obtained by collecting the noise depending on the three types of noise parameters (the positions of the worker, the operational states of the processing apparatus 42, and the operational states of the air conditioner 45) for a long time using the microphone 11, is classified by a statistical method. As a result, the noise data N1 to N12 are created as shown in FIG. 11.

By doing so, if the twelve types of the noise data N1 to N12 are created corresponding to the n (twelve in this embodiment) noise groups, the twelve types of noise data N1 to N12 are superposed on the standard speech data to create the twelve noise-superposed speech data VN1, VN2, . . . , VN12. And then, the noise removal process is performed on the twelve types of noise-superposed speech data VN1, VN2, . . . , VN12 using the optimal noise removal process for removing each of the noise data to create the twelve types of the noise-removed speech data V1′, V2′, . . . , V12′.

And then, the acoustic model learning is performed using the twelve types of the noise-removed speech data V1′, V2′, . . . , V12′ to create the twelve types of the acoustic models M1, M2, . . . , M12. By doing so, the twelve types of the acoustic models M1, M2, . . . , M12 corresponding to the twelve types of the noise data N1, N2, . . . , N12 can be created.

Next, the speech recognition using the n types of acoustic models M1, M2, . . . , Mn, which are created by the aforementioned processes, will be described.

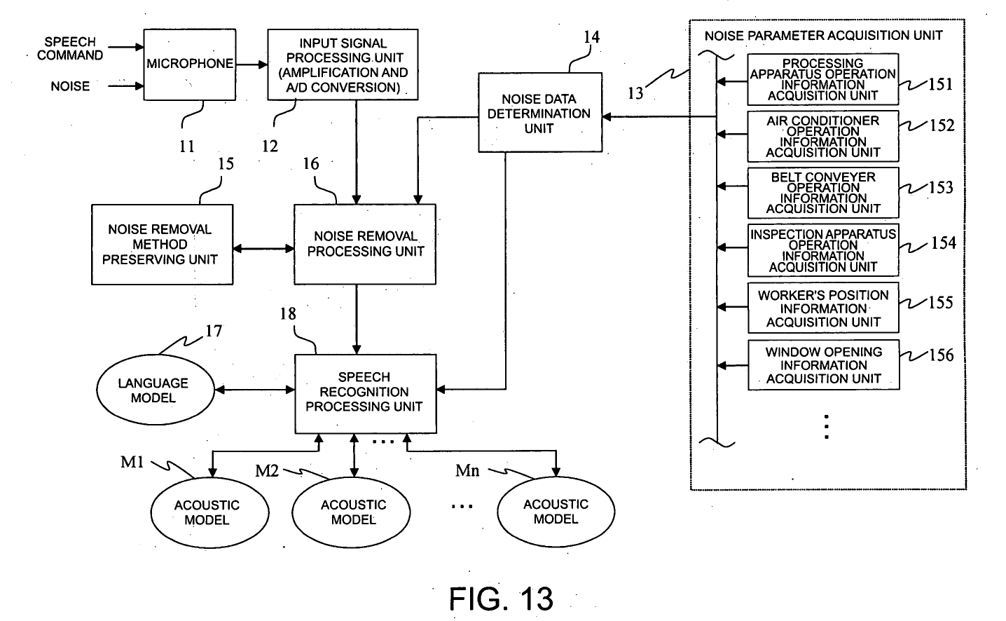

FIG. 13 is a structural view illustrating the speech recognition apparatus used in the second embodiment. The difference from the speech recognition apparatus (see FIG. 7) used in the first embodiment is the contents of the noise parameters that the noise parameter acquisition unit 13 acquires.

In the second embodiment, as described in FIG. 10, the noise parameter acquisition unit 13 can include the processing apparatus operation information acquisition unit 151, the air conditioner operation information acquisition unit 152, the belt conveyer operation information acquisition unit 153, the inspection apparatus information acquisition unit 154, the worker position information acquisition unit 155, and the window opening information acquisition unit 156.

In addition, the noise data determination unit 14 of the speech recognition apparatus shown in FIG. 13 determines which noise data of the plural types of noise data N1 to N12 corresponds to the current noise based on the information from each of the information acquisition units 151 to 156.

For example, at the current position P1 of the worker, if the noise data determination unit 14 receives, as the noise parameters, the information representing that the operational state of the processing apparatus 42 is “high speed”, and the operational state of the air conditioner 45 is “strong wind”, the noise data determination unit 14 determines from the noise parameters which noise data of the noise data N1 to N12 corresponds to the current noise. In this case, the current noise is determined to belong to the noise data N11 in accordance with FIG. 11.

Like this, if the current noise is determined to belong to the noise data N11, the noise data determination unit 14 transmits the determination result to the noise removal processing unit 16 and the speech recognition processing unit 18.

If the noise removal processing unit 16 receives the information that the current noise belongs to the noise data Ni1 from the noise data determination unit 14, the noise removal processing unit 16 performs the noise removal process using the optimal noise removal method on the noise-superposed speech data from the input signal processing unit 12. The noise removal process is implemented by the same method as described in the first embodiment. Thus, the noise removal process is performed on the noise-superposed speech data.

By doing so, if the noise removal process is performed on the noise-superposed speech data (comprising worker's speech commands and the noise inputted into the microphone 11 when the worker's speech commands is inputted) at any time obtained from the microphone 11, the noise-removed speech data from which noise is removed are transmitted to the speech recognition processing unit 18.

The information representing which noise data corresponds to the current noise transmits from the noise data determination unit 14 to the speech recognition processing unit 18. The acoustic model corresponding to the noise data is selected. Then, the speech recognition process is performed using the selected acoustic model and the language model 17.

For example, if the noise data, which is inputted into the microphone 11, is determined to belong to the noise data N11, the speech recognition processing unit 18 utilizes the acoustic model M11 corresponding to the noise data N11 as an acoustic model.

As described in the aforementioned acoustic model creating method, the acoustic model M11 is created such that the noise data N11 is superposed on the speech data, the noise is removed from the noise-superposed speech data to create the noise-removed speech data, and the noise-removed speech data is used to create acoustic models. Thus, when the noise superposed on the worker's speech belongs to the noise data N11, the acoustic model M11 is the optimal acoustic model for the worker's speech, thereby increasing the recognition performance.

In addition, at the current position P3 of the worker, if the noise data determination unit 14 receives, as the noise parameters, the information representing that the operational state of the processing apparatus 42 is “stop”, and the operational state of the air conditioner 45 is “strong wind”, the noise data determination unit 14 determines from the noise parameters which noise data of the noise data N1 to N12 corresponds to the current noise. In this case, the current noise is determined to belong to the noise data N6 in accordance with FIG. 12.

Like this, if the noise data which is inputted into the microphone 11 is determined to belong to the noise data N6, the speech recognition processing unit 18 selects the acoustic model M6 corresponding to the noise data N6 as an acoustic model. Then, the speech recognition process is performed using the selected acoustic model and the language model 17.

As described above, in the speech recognition apparatus of the second embodiment, it is determined which noise data of the noise data N1 to N12 corresponds to the noise superposed on the speech commands. The noise removal is performed using the corresponding noise removal processing method (the same noise removal processing method as is used in the acoustic model creation). Then, the speech recognition is performed using the optimal acoustic model for the speech data (the noise-removed speech data) from which noise is removed.

By doing so, even if various types of noise corresponding to the positions of the worker in the workshop or the noise generated according to circumferential conditions are superposed on the worker's speech, the speech can be recognized using the optimal acoustic model suitable for the noise environments. Thus, it is possible to obtain high recognition performance at the positions of the worker or under the noise environment.

Furthermore, it should be understood that the present invention is not limit to the aforementioned embodiments, and various modifications can be made without departing from the sprit and scope of the present invention.

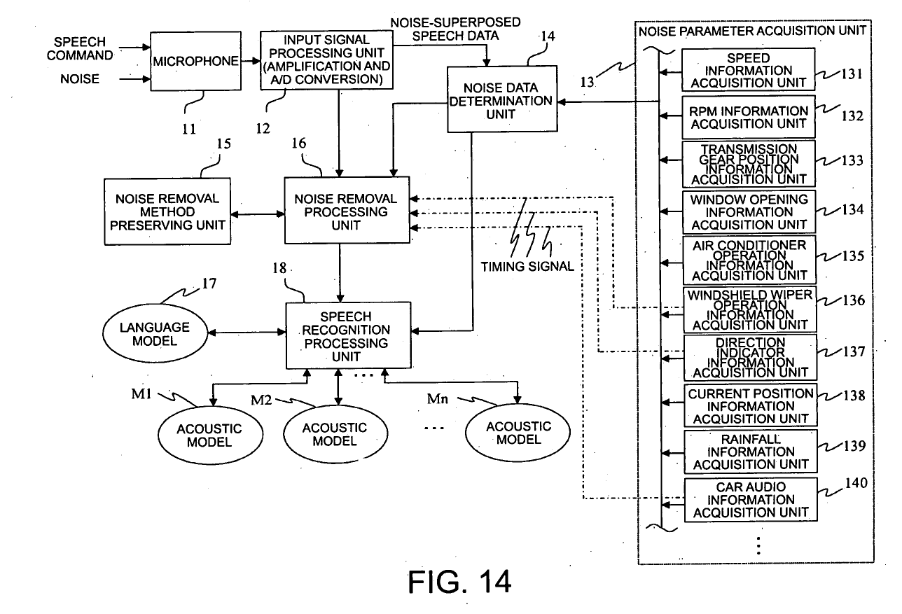

For example, in the aforementioned speech recognition apparatus shown in FIGS. 7 and 13, the noise data determination unit 14 determines which noise data of the n types of the noise data N1, N2, . . . , Nn corresponds to the current noise by inputting the current noise parameters suitable for the car or the workshop. However, as shown in FIG. 14, when the noise data determination is performed, the noise-superposed speech data, (the noise-superposed speech data after the digital conversion) on which the speech data are superposed, are input into the noise data determination unit 14 together with the noise parameters. Then, it may be determined which noise data of the noise data N1, N2, . . . , Nn corresponds to the current noise using the noise-superposed speech data and various noise parameters.

In addition, although FIG. 14 corresponds to FIG. 7 of the first embodiment, it may similarly correspond to FIG. 13 of the second embodiment.

Like this, by inputting the noise-superposed speech data, which are inputted into the microphone 11, to the noise data determination unit 14, it is easy to accurately determine the current S/N ratio. Furthermore, when each of the acoustic models M1 to Mn is created in consideration to the magnitude of the S/N ratio, the optimal acoustic model can be selected in accordance with the current S/N ratio. Thus, it is possible to perform further appropriate speech recognition.

Furthermore, it should be understood that the types of noise parameters are not limited to the aforementioned types described in each embodiment, but the other types can be available. In addition, when in order to create the acoustic models, the car is traveled for a long time or the noise is collected in the workshop and the collected noise is classified by a statistical method to create plural noise data N1 to Nn, a noise parameter may be determined to have no effect on the classification. In this case, at the time of speech recognition, the noise parameter may be excluded from the noise parameters when the noise type determination unit determines the noise types.

In addition, in the aforementioned first embodiment, a car is used as an example of the vehicle, but it is not limited to the car. For example, it is to be understood that the vehicle may include the two-wheeled vehicle, such as auto bicycle, or the other vehicles.

Similarly, although the workshop is exemplified in the embodiments, it is not limited to the workshop, but for example, the distribution center and others may be taken as an example.

Furthermore, according to the present invention, a processing program in which the processing sequence for implementing the present invention is described, is prepared, and the processing program may be recorded in storage medium such at a floppy disc, an optical disc, and a hard disc. Moreover, the present invention includes a recording medium in which the processing program is recorded. In addition, the relevant processing program may be obtained from networks.

As described above, according to the method of creating the acoustic model of the present invention, the noise collected from a certain space is classified to create plural types of noise data. The plural types of noise data are superposed on the previously prepared standard speech data to create plural types of noise-superposed speech data. Then, the noise removal process is performed on the plural types of noise-superposed speech data, and then plural types of acoustic models are created using the plural types of the noise-removed speech data. Thus, it is possible to create the optimal acoustic model corresponding to the various types of noise within the space.

In addition, the speech recognition apparatus according to the present invention performs the noise data determination for determining which noise data of the plural types of the noise data corresponds to the current noise, and the noise removed is performed on the noise-superposed speech based on the result of the noise data determination. And then, the speech recognition is performed on the noise-removed speech using the acoustic model corresponding to the noise data. In addition, the plural types of acoustic models, which the speech recognition apparatus utilizes, are the acoustic models which are created by the aforementioned acoustic model creating method. By doing so, it is possible to perform the optimal noise removal process on the noise that exists within a space. At the same time, since the speech recognition can be performed using the optimal acoustic model for the noise, it is possible to obtain high recognition performance under the peculiar noise environments as a car, a workshop, and the like.

In addition, in the vehicle equipped with the speech recognition apparatus of the present invention, when the driver operates or sets up the vehicle itself or apparatuses mounted in the vehicle, the speech recognition can be performed using an acoustic model suitable for the various noise peculiar to the vehicle. Thus, it is possible to achieve high recognition accuracy and thus to surely operate or set apparatuses by driver's speech.

What is claimed is:

1. An acoustic model creating method for performing speech recognition within a space having noise, the method comprising:
collecting various types of noise collectable within the space having noise;
creating plural types of noise data by classifying the noise collected;
creating plural types of noise-superposed speech data by superposing the plural types of noise data on standard speech data;
creating plural types of noise-removed speech data by performing a noise removal process on the plural types of noise-superposed speech data; and
creating plural types of acoustic models using the plural types of noise-removed speech data.

2. The acoustic model creating method according to claim 1, the noise removal process performed on the plural types of noise-superposed speech data being carried out using a noise removal method suitable for each of the noise data.

3. An acoustic model creating method according to claim 1, the space having noise being a vehicle.

4. An acoustic model creating method according to claim 3, various types of noise collectable within the vehicle being plural types of noise due to effects of at least one of weather conditions, a traveling state of the vehicle, a traveling location of the vehicle, and an operational states of apparatuses mounted in the vehicle.

5. An acoustic model creating method according to claim 1,
collecting noise comprising a recording step of recording individual noise parameters corresponding to the plural types of noise to be collected, and
the plural types of noise to be collected being classified using each noise parameter corresponding to the plural types of noise to be collected, thereby creating the plural types of noise data.

6. A speech recognition apparatus for performing speech recognition within a space having noise, the apparatus comprising:
a sound input device that inputs speech to be recognized and other noise;
plural types of acoustic models created by an acoustic model creating method, the acoustic model creating method comprising: collecting various types of noise collectable within the space having noise; creating plural types of noise data by classifying the collected noise; creating plural types of noise-superposed speech data by superposing the created plural types of noise data on previously prepared standard speech data; creating plural types of noise-removed speech data by performing a noise removal process on the created plural types of noise-superposed speech data; and creating plural types of acoustic models using the created plural types of noise-removed speech data;
a noise data determination device that determines which noise data of the plural types of noise data corresponds to the noise inputted from the sound input device;
a noise removal processing device that performs noise removal on the noise-superposed speech data on which the noise inputted from the sound input device are superposed based on the result of the determination of the noise data determination device; and
a speech recognition device that performs speech recognition on the noise-removed speech data, from which noise is removed by the noise removal processing device, using one of the plural types of acoustic models corresponding to the noise data determined by the noise data determination device.

7. The speech recognition apparatus according to claim 6, the speech recognition apparatus further comprising a noise parameter acquisition device that acquires noise parameters corresponding to the noise inputted from the sound input device.

8. The speech recognition apparatus according to claim 6, the noise removal process on the plural types of noise data obtained by the classification being performed using a noise removal method suitable for each of the noise data.

9. The speech recognition apparatus according to claim 6, the space having noise being a vehicle.

10. The speech recognition apparatus according to claim 9, various types of noise collectable within the vehicle being plural types of noise due to the effects of at least one of weather conditions, a traveling state of the vehicle, a traveling location of the vehicle, and an operational states of apparatuses mounted in the vehicle.

11. The speech recognition apparatus according to claim 6,
collecting noise comprising recording individual noise parameters corresponding to the plural types of noise to be collected, and
the plural types of noise to be collected being classified using each noise parameter corresponding to the plural types of noise to be collected, thereby creating the plural types of noise data.

12. The speech recognition apparatus according to claim 6, the noise removal process at the time of creating the plural types of acoustic models and the noise removal process at the time of performing speech recognition on the speech to be recognized being performed using the same noise removal method.

13. A speech recognition apparatus for performing speech recognition within a space having noise using plural types of acoustic models created by an acoustic model creating method according to claim 1, the apparatus comprising:
a sound input device that inputs speech to be recognized and other noise;
a noise data determination device that determines which noise data of previously classified plural types of noise data corresponds to the current noise inputted from the sound input device;
a noise removal processing device that performs noise removal on noise-superposed speech data on which the noise inputted from the sound input device are superposed based on the result of the determination of the noise data determination device; and
a speech recognition device that performs speech recognition on noise-removed speech data, from which noise is removed by the noise removal processing device, using one of the plural types of acoustic models corresponding to the noise type determined by the noise data determination device.

14. A vehicle having a speech recognition apparatus which is able to be operated by speech, the speech recognition apparatus being the speech recognition apparatus according to claim 6.
